(19) United States
(12) Patent Application Publication
(10) Pub. No.: US 2026/0194865 A1
(43) Pub. Date: Jul. 9, 2026

(54) FINE TUNING OF PROPORTIONAL, INTEGRAL, DERIVATIVE (PID) CONTROL FOR DYNAMIC SYSTEMS

(71) Applicant: University of Florida Research Foundation, Incorporated, Gainesville, FL (US)

(72) Inventors: Baibhab Chatterjee, Gainesville, FL (US); Everestus Ezike, Gainesville, FL (US); Ratul Kundu, Gainesville, FL (US)

(21) Appl. No.: 19/421,830

(22) Filed: Dec. 16, 2025

Related U.S. Application Data
(60) Provisional application No. 63/741,733, filed on Jan. 3, 2025.

(51) Int. Cl. G05B 6/02

(52) U.S. Cl. CPC G05B 6/02

(57) ABSTRACT

A method comprising modifying an integral parameter with an anti-windup correction; modifying a derivative parameter with a bandlimited derivative; and modulating a control signal in accordance with a global optimum that corresponds to one or more operating conditions of a plant system.

### CROSS REFERENCE TO RELATED APPLICATION

This application claims the priority of U.S. Provisional Application No. 63/741,733, entitled “FINE TUNING OF PROPORTIONAL, INTEGRAL, DERIVATIVE (PID) CONTROL FOR DYNAMIC SYSTEMS,” filed on Jan. 3, 2025, the disclosure of which is hereby incorporated by reference in its entirety.

### GOVERNMENT SUPPORT

This invention was made with government support under Grant No. HR0011-23-9-0018, awarded by the Defense Advanced Research Projects Agency (DARPA). The government has certain rights in the invention.

### TECHNICAL FIELD

Various embodiments of the present disclosure relate to dynamic self-tuning of a proportional, integral, derivative (PID) controller that is used on systems that exhibit nonlinear behavior at different operating points.

### BACKGROUND

Traditional heuristic methods approach minimizing controller error by exclusively tuning PID parameters (K_{P}, K_{I}, K_{D}) to optimize a control variable output. For example, an optimization process with respect to the PID parameters may be used to increase efficiency on a plant's system path to a desired setpoint. Existing PID parameter tuning processes may be effective in determining a distinctive local optimum for PID parameters (K_{P}, K_{I}, K_{D}) within a specified static operating condition but may lack the ability to determine a global optimum control quantity for systems that exhibit nonlinear behavior. Nonlinear systems may not have locally defined (e.g., singular) K_{P}, K_{I}, K_{D} settings that perform well in every operating scope. Given that different sets of control quantities may be used to maintain optimal performance throughout a full dynamic operating range of nonlinear systems, a feedback controller configured with a singular control quantity may perform poorly when provided with immeasurable operating changes. Thus, such poor performance may contribute to system output drift, which may occur when a stabilized system output begins to deviate off a set point.

### BRIEF SUMMARY

Various embodiments described herein relate to methods, apparatus, systems, computing devices, computing entities, and/or the like for performing adaptive integral, derivative (PID) control within a plant system process. According to some embodiments, a method comprises modifying an integral parameter with an anti-windup correction; modifying a derivative parameter with a bandlimited derivative; and modulating a control signal in accordance with a global optimum that corresponds to one or more operating conditions of a plant system.

In some embodiments, the anti-windup correction comprises integrator clamping that resolves actuator saturation. In some embodiments, the bandlimited derivative comprises a Butterworth low-pass filter structure with N order, L-filter levels coupled with a complex derivative parameter. In some embodiments, modulating the control signal comprises verifying a plant system process corresponding to the plant system adheres to a linear behavioral model; generating a linear mapping function, wherein a y-intercept configures no action in the plant system process and a slope parameter dictates a factor by which responsivity in a control parameter adjusts with the control signal; static tuning one or more of the integral parameter, the derivative parameter, or a proportional parameter under a constant operating condition; and applying slope tuning on the linear mapping function to facilitate dynamic operation of the plant system process. In some embodiments, verifying the plant system process comprises identifying one or more process variables and one or more control parameters belonging to the plant system process; and assessing how the one or more process variables behave in response to one or more incremental changes to the one or more control parameters. In some embodiments, generating the linear mapping function comprises determining the y-intercept with a coordinate that corresponds to the no action in the plant system process and flexibly shapes the slope parameter. In some embodiments, static tuning comprises maintaining no change in the linear mapping function; initializing the plant system process with a behavior described by the y-intercept in the linear mapping function; maintaining the plant system process under the constant operating condition; and obtaining a local optimum control quantity corresponding to one or more of the integral parameter, the derivative parameter, or the proportional parameter. In some embodiments, applying the slope tuning comprises determining how the plant system process reacts to one or more changes in the linear mapping function; determining M number of points in a moving average of a process variable; forming a boundary around the process variable; modifying a slope of the linear mapping function by a constant margin.

According to some embodiments, a method comprises verifying a plant system process for dynamic tuning candidacy; generating a linear mapping function; static tuning one or more of an integral parameter, a derivative parameter, or a proportional parameter; and applying slope tuning on the linear mapping function in providing dynamic operation of the plant system process.

In some embodiments, verifying the plant system process comprises determining a process variable and a control parameter; generating a behavioral model of the plant system process; and determining how the process variable reacts to the control parameter. In some embodiments, the method further comprises, responsive to a moving average of the process variable decreasing below a lower bound of a set point, decreasing a slope parameter of the linear mapping function. In some embodiments, the method further comprises, responsive to a moving average of the process variable increasing above an upper bound of a set point, increasing a slope parameter of the linear mapping function. In some embodiments, generating the linear mapping function comprises determining a y-intercept that corresponds to a control parameter prompting no action in the plant system process; determining a slope parameter that dictates a factor by which responsivity in the control parameter adjusts with a control signal; and generating, using a point-slope form, the linear mapping function. In some embodiments, static tuning one or more of the integral parameter, the derivative parameter, or the proportional parameter comprises maintaining a slope parameter at constant; initializing the proportional parameter, the integral parameter, and the derivative parameter to 0 and maintaining an operating condition of the plant system process at constant; determining a proportional parameter value by modifying or increasing the proportional parameter until a steady-state error is low while maintaining the integral parameter and the derivative parameter at constant; determining an integral parameter value by modifying or increasing the integral parameter until the steady-state error is eliminated while maintaining the proportional parameter and the derivative parameter at constant; determining a derivative parameter value by modifying or increasing the derivative parameter as appropriate to relax oscillations and improve settling time while maintaining the proportional parameter and the integral parameter at constant; and maintaining one or more of the proportional parameter value, the integral parameter value, or the derivative parameter value as a local optimum control quantity. In some embodiments, applying slope tuning comprises determining how the plant system process reacts to one or more changes in the linear mapping function. In some embodiments, applying slope tuning comprises configuring M number of points in a moving average of a process variable; configuring an upper bound and a lower bound relative to a set point; and configuring a constant margin to add or subtract from a slope parameter of the linear mapping function. In some embodiments, applying slope tuning comprises waiting a time limit for the process variable to stabilize between an established boundary; and after the time limit, changing the slope parameter by the constant margin.

### BRIEF DESCRIPTION OF THE DRAWINGS

Embodiments incorporating teachings of the present disclosure are shown and described with respect to the figures presented herein.

FIG. 1 depicts a diagram of an example closed-loop control system.

FIG. 2 depicts an example voltage temperature profile.

FIG. 3 depicts example relationship trends between an imposed pulse-width modulated PWM duty cycle on supply voltage and source current of a heat actuator.

FIG. 4 depicts an example diagram of a plant system architecture.

FIG. 5 depicts performance comparisons between a normal controller and a controller with an anti-windup correction scheme.

FIG. 6 depicts a Bode plot of an N-order, L-filter levels bandlimited derivative.

FIG. 7 depicts a MATLAB Simulink simulation of a bandlimited derivative.

FIG. 8 depicts a system level block diagram of an example proportional, integral, derivative (PID) control system in accordance with some embodiments of the present disclosure.

FIG. 9 depicts a function that maps a control signal to an appropriate actuator input signal in accordance with some embodiments of the present disclosure.

FIG. 10 depicts example measurements associated with stabilizing a process variable of a plant system in accordance with some embodiments of the present disclosure.

FIG. 11 depicts improved measurements associated with stabilizing a process variable of a plant system in accordance with some embodiments of the present disclosure.

FIG. 12 is a flowchart of an example process for performing adaptive PID control according to some embodiments of the present disclosure.

FIG. 13 is a flowchart of an example dynamic PID heuristic process for stabilizing a process variable of a plant system in accordance with some embodiments of the present disclosure.

### DETAILED DESCRIPTION

Various embodiments of the present disclosure now will be described more fully hereinafter with reference to the accompanying drawings, in which some, but not all embodiments of the disclosure are shown. Indeed, the disclosure may be embodied in many different forms and should not be construed as limited to the embodiments set forth herein. Rather, these embodiments are provided so that this disclosure will satisfy applicable legal requirements. The term “or” is used herein in both the alternative and conjunctive sense, unless otherwise indicated. The terms “illustrative,” “example,” and “exemplary” are used to be examples with no indication of quality level. Like numbers refer to like elements throughout.

### General Overview and Example Technical Improvements

As described above, there are many technical challenges and difficulties associated with existing proportional, integral, derivative (PID) parameter tuning processes. Various example embodiments of the present disclosure overcome such technical challenges and difficulties in existing PID parameter tuning processes and provide various technical advancements and improvements. In accordance with various embodiments of the present disclosure, a method for gain scheduling is disclosed for resolving system output drift. In some embodiments, a gain schedule comprises scheduling adjustments to a characterized slope of a system's linear behavioral trend that is arranged according to a system output's moving average and is supplemented with compensation techniques for integrator windup and derivative kickback to form adaptive control quantities that align with static and dynamic system changes.

### Example Technical Implementation of Various Embodiments

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable storage media (including volatile and non-volatile media).

A non-volatile computer-readable storage medium may include one or more magnetic and/or electro-mechanical storage devices, such as floppy disk(s), hard disk(s), magnetic tape, punch card(s), paper tape(s), optical mark sheet(s) (or any other physical medium with patterns of holes or other optically or mechanically detectable indicia), any other non-transitory magnetic medium, and/or the like. A non-volatile computer-readable storage medium may additionally or alternatively include one or more optical storage devices, such as compact disc read only memory (CD-ROM), compact disc-rewritable (CD-RW), any other non-transitory optical medium, and/or the like. A non-volatile computer-readable storage medium may additionally or alternatively include one or more read-only memory (ROM); programmable read-only memory (PROM); erasable programmable read-only memory (EPROM); electrically erasable programmable read-only memory (EEPROM), such as flash memory; and/or the like. In some examples, flash memory may comprise a set of field effect transistors and/or other devices or circuitry that implement serial and/or parallel NAND, NOR, and/or other hardware logic for storing data. In some examples, solid state storage (SSS), such as a solid state drive (SSD), flash drive, solid-state hybrid drives (SSHDs), and/or the like may include flash memory (SSHDs are a hybrid device that may include a hard disk and flash memory in some examples); and, in some examples, flash memory may be used as cache memory, implemented as a basic input output system (BIOS) chip or part of a BIOS chip, and/or the like. A non-volatile computer-readable storage medium may additionally or alternatively include 3D XPoint memory, non-volatile random access memory (NVRAM) (e.g., bridging random access memory (CBRAM), phase-change random access memory (PRAM), magnetoresistive random-access memory (MRAM), ferroelectric random-access memory (FeRAM)), racetrack memory, and/or the like. A non-volatile computer-readable storage medium may additionally or alternatively include one or more thermo-mechanical storage devices, such as Millipede memory; one or more molecular memory repositories; and/or the like.

A volatile computer-readable storage medium may include random access memory (RAM), dynamic random access memory (DRAM), static random access memory (SRAM), synchronous dynamic random access memory (SDRAM), cache memory (including various levels), register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### Example System Architecture and Operations

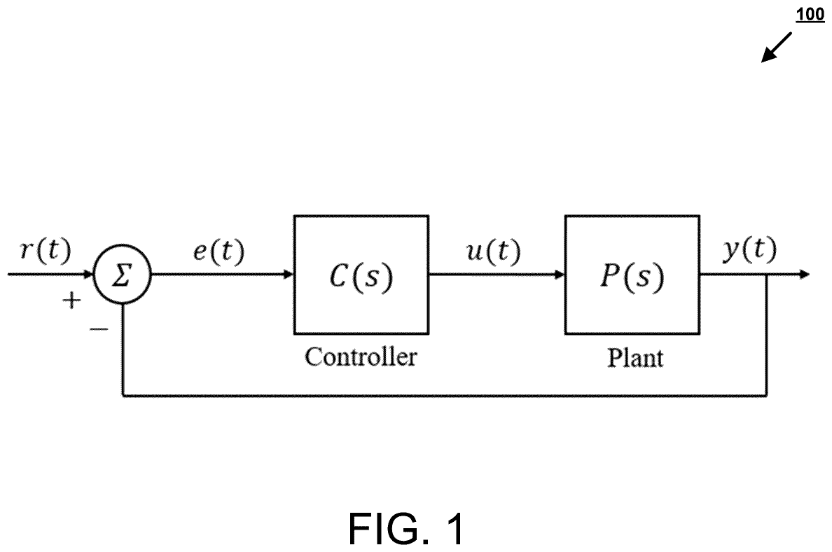

FIG. 1 depicts a diagram of an example closed-loop control system 100. Closed-loop control architectures may comprise system configurations that attempt to provide desired system responses. The closed-loop control system 100 comprises a plant system process P(s) that converts control decisions to physical outputs within a process environment that may be routinely measured and converted to appropriate electrical signals using actuators and sensors. A controller C(s) regularly processes the difference between a desired reference signal r(t) and a plant output y(t) into a control signal u(t) that is sufficient for maintaining the process environment at a desired output level.

In some embodiments, a plant system comprises a subject that is controlled by a control system to achieve a desired output. The plant system may provide output in the form of one or more process variables that may be measured and controlled, such as temperature, to provide the desired output of the plant system. A sensor may be used to measure a process variable and provide feedback to the control system. A set point may comprise a desired or target value for the process variable. The plant system may be acted upon by an actuator and produce an output that is measured by a control system via a sensor to adjust output of the actuator such that a desired outcome may be achieved by the plant system. That is, at any given moment, a difference between the process variable and the set point is used by the control system to determine a desired actuator output to drive the plant system.

According to various embodiments of the present disclosure, a dynamic controller is disclosed herewith that is compatible with any plant system process comprising a linear behavioral trend that is associated with a process environment, an actuator, and a sensor. A process environment may comprise (i) a plant system that is controlled and (ii) one or more process variables and/or additional parameters that respectively (a) convey a current state of the system and (b) influence its state. An actuator may convert electrical signals from a control module to a physical output that drives mechanical events. A sensor may monitor the physical condition of the process environment and transmit this information through electrical signals to a control center. The disclosed dynamic controller may be used in various domains, such as automotive (e.g., cruise control), agriculture (e.g., irrigation management and livestock feeding systems), biomedical (e.g., device regulation of patient temperature and blood glucose levels), consumer (e.g., water level maintenance in washing machines), industrial (e.g., chemical and food processing), and manufacturing (e.g., regulation of pressure, voltage, and pH level) industry. As disclosed herewith, some embodiments are directed to an implementation of a controller on a plant system (e.g., temperature system) that exhibits linear behavioral characteristics.

In some embodiments, a heuristic process is applied to effectively stabilize a process variable that is associated with a plant environment whose behavior does not perfectly conform to a linear mathematical function in a dynamic operating state. In some embodiments, an adaptive heuristic process comprises global optimum control quantities (K_{P}, K_{I}, K_{D}) throughout an entire operating range of a nonlinear plant. In some embodiments, a nonlinear plant comprises a plant that shows linear behavioral properties but does not fully obey any prescribed linear mathematical curve.

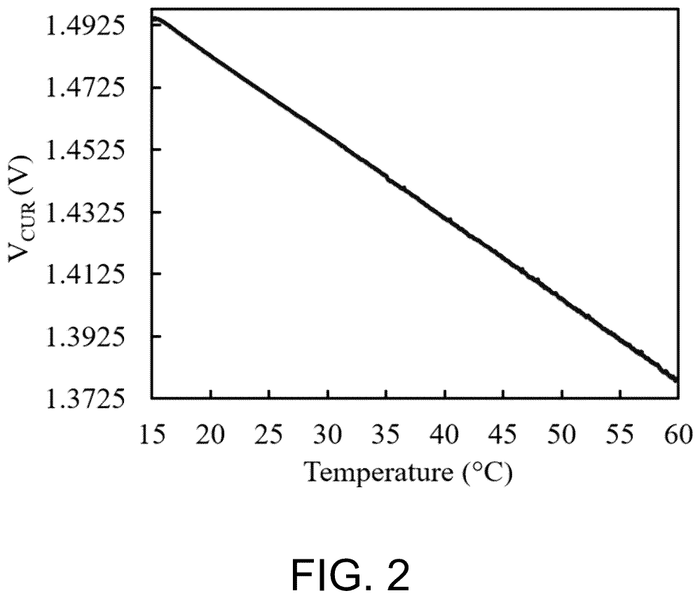

FIG. 2 depicts an example voltage temperature profile. A plant system may comprise a conductive material that is held on a printed circuit board (e.g., a silicon interposer for AlScN-on-Si shear-bulk acoustic wave (BAW) resonator) containing a temperature sensor (e.g., a complimentary to absolute temperature (CTAT) sensor used in feedback control of an adaptive PID software algorithm) and a p-channel (or power metal-oxide-semiconductor field-effect transistor (MOSFET)) heat actuator. The depicted voltage may be generated by using a temperature sensor, which indicates a temperature sensed on the conductive material. A pulse width modulation (PWM) signal may modify a temperature produced by the p-channel heat actuator, where a duty cycle closer to 0% may correlate with increased temperature. Given that heat generated from the heat actuator is a proportional function to power dissipation, heat may be represented in terms of a multiplication between supply voltage (Vs) and source current (Is) of the heat actuator.

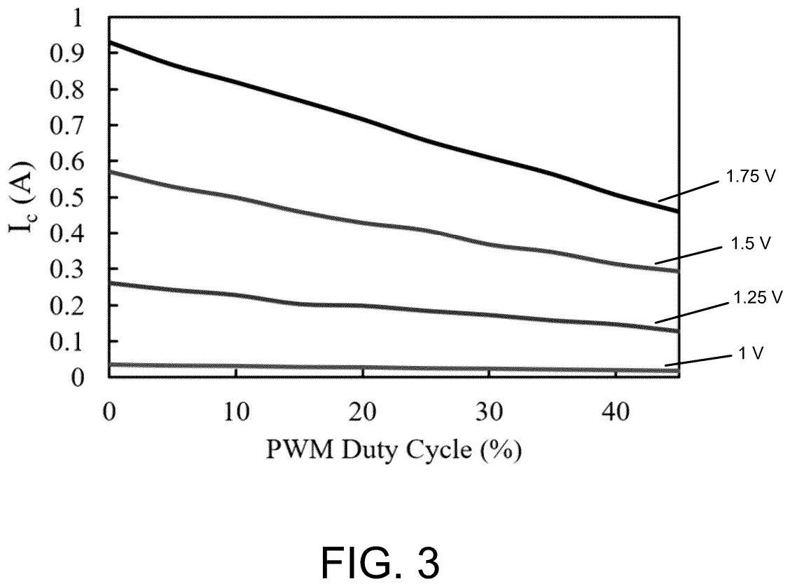

FIG. 3 depicts example relationship trends between an imposed PWM duty cycle on Vs and Is. Temperature stability near a target temperature (T_{TAR}) on the conductive material may be achievable from provisional data obtained from the temperature sensor if the following control specifications outlined are adhered to: if the current temperature T_{CUR}<T_{TAR}, then achieving V_{CUR}>V_{TAR} and a decrease in duty cycle may increase T_{CUR} toward T_{TAR}; if T_{CUR}>T_{TAR}, then achieving V_{CUR}<V_{TAR} and an increase in duty cycle may decrease T_{CUR} toward T_{TAR}; if T_{CUR}=T_{TAR}, then achieving V_{CUR}=V_{TAR} and no change in duty cycle may maintain T_{TAR}.

A PID controller design may be selected to ascertain a mode of control for such a plant system process to approach and maintain long-term temperature stability on the conductive material at T_{TAR} by managing the plant system's process variables with a microcontroller unit (MCU) that bases control decisions on a dynamic PID heuristic using peripheral devices, such as (i) an analog-to-digital converter (ADC) to obtain V_{CUR} from the temperature sensor and (ii) a timer array unit to produce a PWM signal.

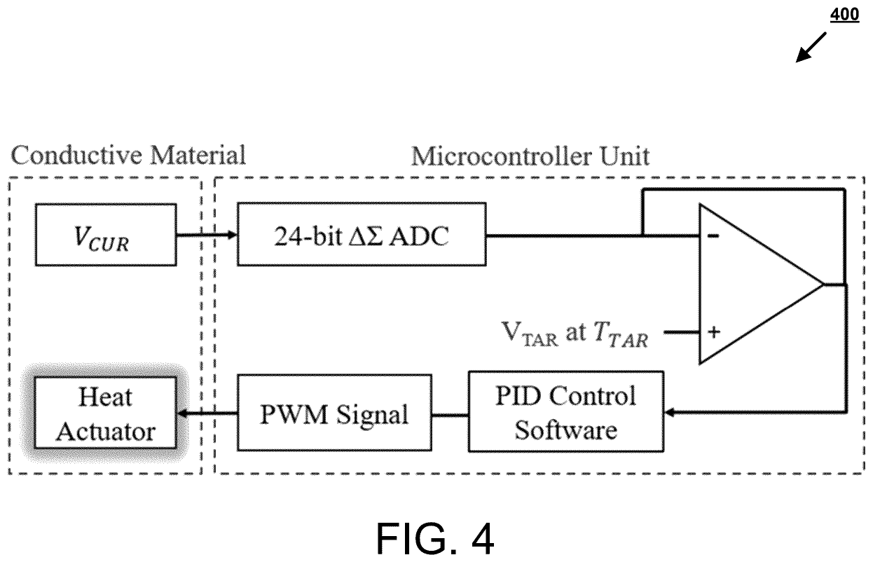

FIG. 4 depicts a block diagram of an example plant system architecture 400. To meet the aforementioned control specifications, some embodiments comprise a proportional-only controller and a plant system process with a heat actuator. A proportional controller may be configured to restore a plant system's response to a desired system outcome by establishing a PWM control signal u(t) that scales linearly with respect to a proportional parameter K_{P} and an error signal e(t). The proportional controller may attempt to reduce error between V_{TAR} and V_{CUR} by applying proportional control but may be limited in performance from system offset deviations. A system offset may comprise a deviation between the desired setpoint r(t) and the resulting plant system output y(t) after a system adjustment u(t).

For example, consider a 0.5V step input change at time to between signals V_{TAR} and V_{CUR}, where the error before to may be negligible. If an error between V_{TAR} and V_{CUR} is reduced to zero, a controller may cease to apply any duty cycle that maintains heat actuator activity and V_{CUR} may increase thereafter due to cooling. Assuming a plant system may call for a 60% duty cycle to stabilize in a static condition, the following proportional parameter constants may be suitable to reduce error by the quantities outlined:

$$duty cycle = {K}_{P} \cdot e ( t ) = 150 \cdot 0.4 = 200 \cdot 0.3 = 300 \cdot 0.2 = 600 \cdot 0.1 = 60. \qquad Equation 1$$

Thus, beginning from to, the plant system may meet a steady-state error limit when proportional-only control is applied, regardless of control signal quality. Supplementation of integral action may provide distinct benefits to proportional-only controllers (e.g., an integrator reduces or removes steady-state error). Integral action may remove steady-state error by adding a parameter to the control effort which may account for a total error accumulated over time (assuming a plant system calls for a 60% duty cycle to stabilize a static condition where V_{TAR}>V_{CUR}, and the error before to is negligible in an integrator-only controller).

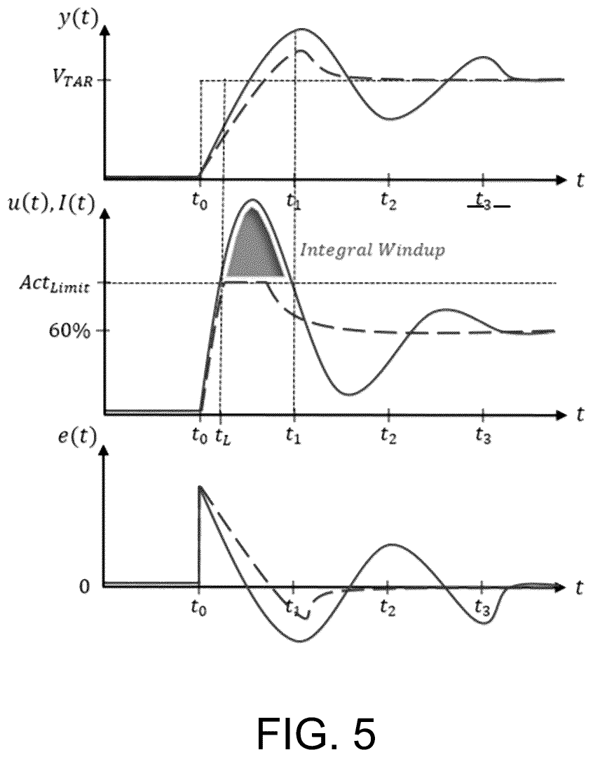

FIG. 5 depicts performance comparisons between a normal controller and a controller with an anti-windup correction scheme. As depicted with a step input in a target signal at to, an integral-only controller modifies parameters in a plant system to approach and maintain a new set point by utilizing an integral parameter to stabilize u(t) at approximately 60% duty cycle. Accordingly, a proportional process may contribute no control decisions in steady-state; thus, all responsibility may fall upon the integral process to determine the control signal which achieves zero steady-state error.

As shown by a solid line in FIG. 5, a nonlinear, detrimental effect is observed during t_{L}-t₁. Actuators may have limits on their acceptable range of inputs. For example, a heat actuator may tolerate a duty cycle ranging from 0-100%. When a controller crosses the actuator limit Act_{Limit} at t_{L}, the control input u(t) to the actuator becomes saturated while the error signal e(t) continues to be integrated, thereby causing the integrator to wind up, i.e., accumulate. When the actuator becomes saturated, the controller may be caused to effectively operate in a nonlinear region where the feedback loop is broken. Integrator windup may lead to the control input u(t) to drive the plant system output y(t) beyond a setpoint, and when the control signal exits saturation, a large integral parameter remains and may cause large disturbances in the plant system output y(t) before eventually achieving recovery near the set point.

FIG. 5 further depicts in dashed lines, a signal response derived from a clamping anti-windup mechanism, showing an addition to allow the controller to experience greater recovery from nonlinearity and overshoot, and with improved stability. An anti-windup scheme comprising integrator clamping based on conditional integration may be incorporated in the controller to address problems associated with actuator saturation. Conditional integration may comprise integral action that is applied when certain conditions are met. For example, halting additional increases (or decreases) to the integral parameter after the control signal reaches the upper (or lower) actuator limit may be a condition that is respected to remove the effects of integrator windup. To adhere to such a condition, a saturation block may be used to limit the controller from increasing past limits set by the actuator, and a comparison of the control signal before and after meeting the saturation block may be performed to determine if actuator saturation occurred anytime during control signal processing.

Moreover, the sign of the error and control signals may be examined. Error and control signals that share equivalent signs may correspond to an increasing integrator on either end of the actuator limit, and error and control signals that differ in sign may correspond to a decreasing integrator on either end of the actuator limit. Integration may be stopped when the actuator is saturated on the upper end (or lower end), leading to a further increase (or decrease) in the integral parameter. Thus, clamping may comprise pausing integration when the sum of all control components exceeds the actuator limit, and the control signal u(t) and error signal e(t) have equivalent signs.

Integral parameter K_{I} may be alternatively expressed in terms of an inversely proportional constant known as the integral time T_{I}. The integral time Ty may represent the time necessary for integral action to produce a net change in u(t) that is equal in magnitude to the net change produced by a proportional action. A decrease in T_{I} may move a control system toward zero steady-state error more quickly; however, a physical threshold exists in how small the quantity T_{I} may be without causing detriment to overall system stability. Rather than increase the rate at which control decisions are made, derivative action may dampen the control effort at the expense of speed in proportional (K_{P}), integral (K_{I}) (PI) control to throttle the control system to move no faster than a setpoint velocity. As such, derivative action may lead to improved system tolerance of external disturbances, and under optimal conditions, plant system output y(t) may be stabilized with minimal overshoot along a desired reference signal in the least amount of time. Derivative action, however, may require modifications to resolve an issue with its formal definition.

According to L{e′(t)u(t)}=sF(s), the Laplace transform of a portion attributing to

$$L \{ \frac{d}{dt} \} = s$$

may be characterized by the magnitude |H(jω)|=ω and the phase ∠H(jω)=90°. Based on such a characterization, the derivative may amplify higher frequencies by a factor of 20 decibels/decade, which may present complications since physical quantities may be subject to random high frequency fluctuations where noise resides. Furthermore, s may represent an improper transfer function whose system cannot be both causal and stable. That is, if the degree of the numerator is greater than the degree of the denominator, at least one pole will be at infinity. Therefore, a pure derivative definition may be modified to attain properties of causality and stability.

The definition of a derivative may be modified accordingly to attain a causal definition:

$$\frac{de ( t )}{dt} ≅ \frac{e ( t ) - e ( t - 1 )}{T} + \frac{n ( t )}{T} . \qquad Equation 2$$

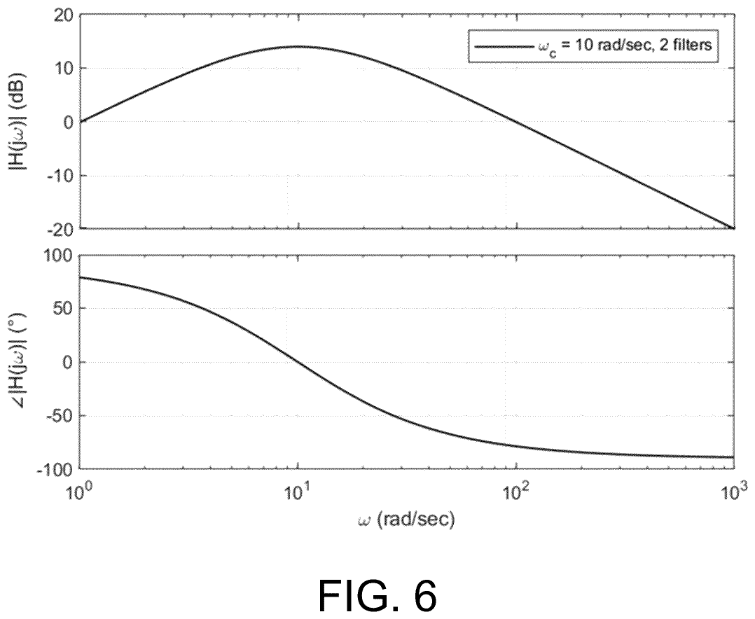

From the modified definition, noise n(t) that is imparted onto derivative control may be suppressed by increasing the sampling period T. However, instead of limiting the system to lower operating speeds, an alternative that does not bottleneck the system overall may comprise the use of low-pass filtering. A low-pass filter along with a derivative parameter may provide a band-limited derivative, (e.g., a proper transfer derivative). If a Butterworth filter structure is chosen with N-order, L-filter levels, the bandlimited derivative design may conform to

$$L \{ \frac{\text{?}}{dt} \} = s \cdot {[ H ( s ) ]}^{L} = s \cdot {[ \frac{1}{{B}_{N} ( s )} {\vert}_{s ⇒ \frac{s}{{ω}_{c}}} ]}^{L} , \qquad Equation 3$$

where the behavior of the modified derivative may be represented with the bode plot of a 1^{st} order, 2-filter levels, as depicted in FIG. 6.

Although an improper transfer function may not be developed in practice, a system may be designed to imitate the behavior of an improper function. For example, a pure sinusoidal error signal e(t)=sin(t) and a uniform, randomly distributed 1 kHz noise in the range of =0.3 added on top of e(t) may be considered.

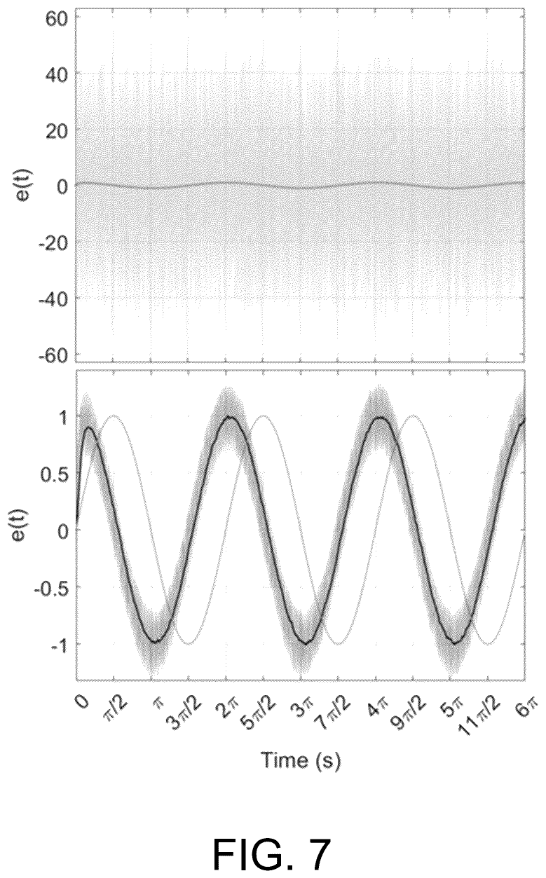

FIG. 7 depicts example signals of a MATLAB Simulink simulation for a bandlimited derivative with a cut-off frequency of 0 rad/sec ([top image]; 1-filter, ω_{c}=0 rad/sec) that shares similar behavior to a pure derivative. That is, the depicted bandlimited derivative effectively amplifies the noise in the real signal and leaves behind no trace of the pure sinusoidal error signal. However, a band-limited derivative with a 10 rad/sec cutoff frequency ([top image]; 1-filter, ω_{c}=10 rad/sec) provides a desired characteristic of noise attenuation and uncovers a pure 1 rad/sec sinusoidal error signal.

A closer view of the underlying signal in FIG. 7 shows discrepancies between the uncovered signal ([bottom image]; 1-filter, ω_{c}=10 rad/sec) and the pure 1 rad/sec sinusoidal signal ([bottom image]; ωᵢₙ=1 rad/sec). Despite restoring the general shape of the sinusoidal signal, significant noise remains. To resolve this, additional L levels of filtering ([bottom image]; 2-filter, ω_{c}=10 rad/sec) may be included in series to suppress the remaining noise signal at the cost of additional phase lag. Besides shortcomings in phase offset, derivative action is also not immune to disturbances from process changes in the desired setpoint.

Derivative kickback may refer to a setting where large derivative correction is made to compensate for an adjustment in the system setpoint. In a state of derivative kickback, derivative action may cause undue stress on the control effort by saturating the controller instantaneously on either side of the actuator limit. Given

$$\frac{{[ {V}_{TAR} ]}_{t} - {[ {V}_{TAR} ]}_{t - 1}}{T}$$

as the velocity setpoint and

$$\frac{{y}_{t} - {y}_{t - 1}}{T}$$

as the plant system output's velocity between timestep samples t, if the setpoint is constant, the implicit velocity setpoint may be zero, and the derivative constant K_{D} may progressively influence the plant system's speed to approach the setpoint velocity using only the difference of the plant output. Thus, if the setpoint (V_{TAR}) is treated as a constant parameter, derivative kickback may no longer pose potential issues, and

$$\frac{\text{?}}{d t} = \frac{e ( t ) - e ( t - 1 )}{T} = \frac{( {[ {V}_{TAR} ]}_{t} - {y}_{t} ) - ( {[ {V}_{TAR} ]}_{t - 1} - {y}_{t - 1} )}{T} = \frac{{[ {V}_{TAR} ]}_{t} - {[ {V}_{TAR} ]}_{t - 1}}{T} - \frac{{y}_{t} - {y}_{t - 1}}{T} ≅ - \frac{\text{?}}{d t} \qquad Equation 4$$

holds if V_{TAR} is constant.

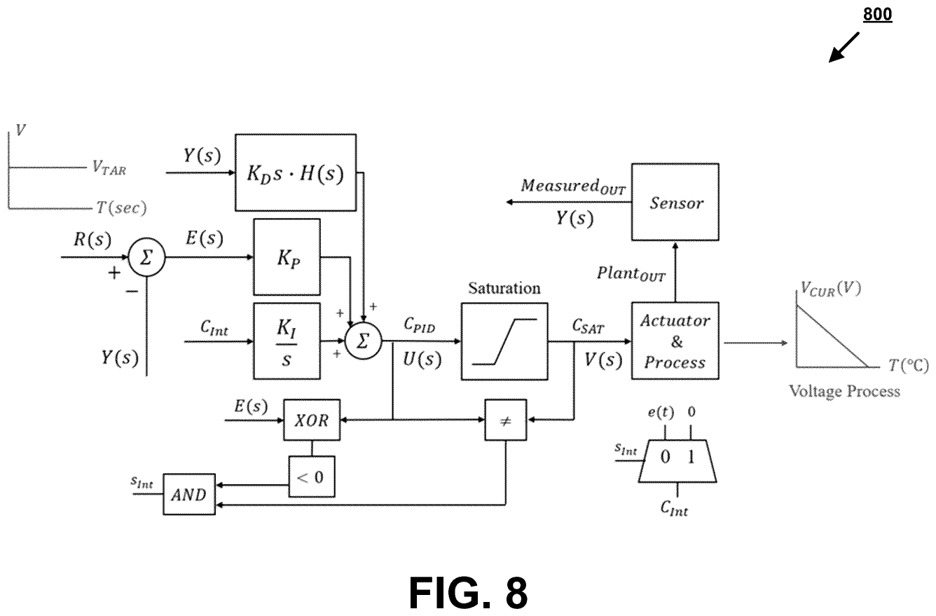

FIG. 8 depicts a system level block diagram of an example PID control system 800 to counteract integrator windup and derivative kickback events in accordance with some embodiments of the present disclosure. A frequency transformation of a continuous-time PID expression may be defined according to the following by using a derivative computation on a plant output Y(s) and a 1-filter, 2^{nd} order Butterworth low-pass filter for maximal noise attenuation and minimal offset phase:

$$U ( s ) = {K}_{P} E ( s ) + {K}_{I} \frac{E ( s )}{s} - {K}_{D} Y ( s ) \frac{{s ω}_{c}^{2}}{{s}^{2} + {ω}_{c} \sqrt{2} s + {ω}_{c}^{2}} = P ( s ) + I ( s ) + D ( s ) . \qquad Equation 5$$

The error signal E(s) is computed on the difference between R(s) (e.g., V_{TO}) and Y(s) (e.g., V_{CUR}) and is processed using a MCU to apply PID control on a plant environment (e.g., interposer). A plant may comprise a CTAT voltage output signal (e.g., V_{CUR}) that is influenced by the PID control signal (e.g., U(S)), fed as an input to a power MOSFET actuator to adapt a temperature environment on the plant environment to comply with a desired temperature characteristic, R(s). An analog-to-digital converter (ADC) on the MCU may be used as a sensor to evaluate the plant output (e.g., V_{CUR}) and manage negative feedback between the control architecture and the plant system process.

A bilinear transformation may be used to convert the transfer function of a linear-time invariant filter in the continuous-time domain U(s) to a transfer function in the discrete-time domain u[n].

$${s}_{a} = {σ}_{a} + j {ω}_{a} = \frac{2}{{T}_{s}} [ \frac{z - 1}{z + 1} ] = \frac{2}{T} [ \frac{r {e}^{j {ω}_{d}} - 1}{r {e}^{j {ω}_{d}} + 1} ] = \frac{2}{{T}_{s}} [ \frac{{r}^{2} - 1}{{r}^{2} + 1 + 2 {r cos ω}_{d}} + j \frac{2 {r sin ω}_{d}}{{r}^{2} + 1 + 2 {r cos ω}_{d}} ] \qquad Equation 6$$

According to Equation 6, a bilinear transformation may form a nonlinear relationship between analog frequency (ωₐ) and digital frequency (ω_{d}). As a result, a frequency specified for an analog filter may be pre-warped to have greater conversion accuracy of the cutoff frequency in the discrete-time domain.

$${ω}_{c} = {ω}_{a , cutoff} = \frac{2}{{T}_{s}} [ \frac{2 {r sin ω}_{d}}{{r}^{2} + 1 + 2 {r cos ω}_{d}} ] = \frac{2}{{T}_{s}} tan [ \frac{{ω}_{d}}{2} ] = \frac{2}{{T}_{s}} tan [ π \frac{{f}_{c}}{{f}_{s}} ] \frac{rad}{sec} \qquad Equation 7$$

The cut-off frequency of a low-pass filter (f_{c}) may be designed to avoid the effects of aliasing. Aliasing may refer to an event where two distinct continuous-time signals x₁(t) and x₂(t) produce a same sample sequence x[n] when sampled at a fixed rate fₛ. For any integer k, all frequencies f₂ that comply with kfₛ±f₁ are aliases of each other, and if two continuous-time signals x₁(t) and x₂(t) are comprised of the frequency f₁ and f₂ respectively, their samples at fₛ may produce identical samples: x₁[n]=x₂[n] for all n=0, 1, 2, . . . . According to the Nyquist-Shannon theorem, the integrity of a sampled signal remains uncorrupted from the effect of aliasing if the sample rate is greater than twice the input signal's highest frequency component fₛ≥2fᵢₙ. If a low-pass filter is designed with a bandwidth greater than fᵢₙ and lower than the Nyquist frequency fᵢₙ=fₛ/2, then higher order frequency components may be removed so that only fᵢₙ remains. To ensure the input signal's frequency spectrum contains no significant spectral content above fₙ, before sampling and after reconstruction, a low-pass filter designed for the band-limited derivative may be implemented with a cut-off frequency that complies with fᵢₙ<f_{c}<fₛ/2 to prevent inaccurate evaluations on control signals processed. If both the bilinear transformation and inverse z-transform are applied to U(s), a derivation of the discrete-time PID algebraic equation may be represented by the following expressions.

$$u [ n ] = p [ n ] + i [ n ] + d [ n ] \qquad Equation 8$$

$$p [ n ] = {K}_{P} e [ n ] \qquad Equation 9$$

$$i [ n ] = \frac{{T}_{s} {K}_{I}}{2} ( e [ n ] + e [ n - 1 ] ) + i [ n - 1 ] \qquad Equation 10$$

$$on y ( t ) \to d [ n ] = - [ \frac{( ( y [ n ] - y [ n - 2 ] ) {K}_{D} + d [ n - 1 ] ( {T}_{s} - \frac{4}{{ω}_{c}^{2} {T}_{s}} ) + d [ n - 2 ] ( \frac{2}{{T}_{s} {ω}_{c}^{2}} - \frac{\sqrt{2}}{{ω}_{c}} + \frac{{T}_{s}}{2} )}{( \frac{2}{{T}_{s} {ω}_{c}^{2}} + \frac{\sqrt{2}}{{ω}_{c}} + \frac{{T}_{s}}{2} )} ] \qquad Equation 11$$

$$on e ( t ) \to d [ n ] = - [ \frac{( e [ n ] - e [ n - 2 ] ) [ - {K}_{D} ] + d [ n - 1 ] ( {T}_{s} - \frac{4}{{ω}_{c}^{2} {T}_{s}} ) + d [ n - 2 ] ( \frac{2}{{T}_{s} {ω}_{c}^{2}} - \frac{\sqrt{2}}{{ω}_{c}} + \frac{{T}_{s}}{2} )}{( \frac{2}{{T}_{s} {ω}_{c}^{2}} + \frac{\sqrt{2}}{{ω}_{c}} + \frac{{T}_{s}}{2} )} ] \qquad Equation 12$$

A plant system process may comply with three behavioral trends that relate V_{CUR} to the required PWM duty cycle response which reaches V_{TAR}. From the trends listed below, a linear control model may be extrapolated to determine the most appropriate PWM signal that is applied with respect to any control signal value u[n] produced to stabilize the temperature of the conductive material about T_{TAR}. From these constraints, a linear mapping function may be created to represent the behavior of the plant system process.

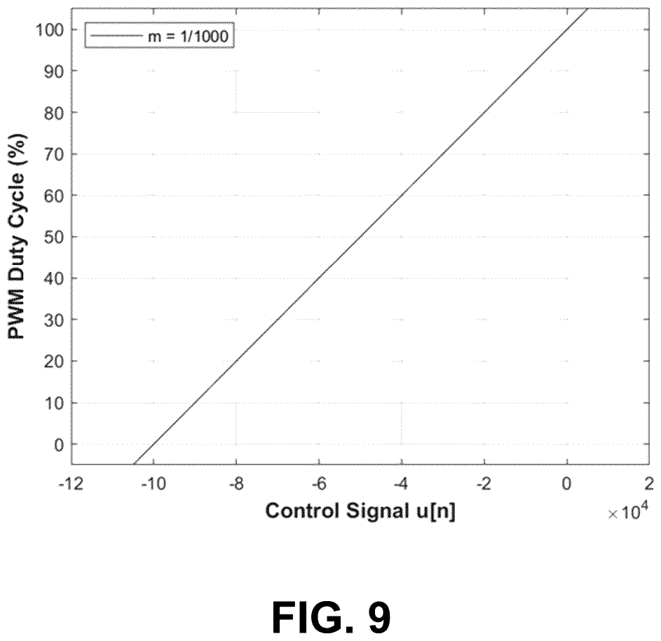

FIG. 9 depicts a function that maps a control signal value u[n] to an appropriate actuator input signal (e.g., PWM signal) that inflicts a desired outcome in a plant system's process variables (e.g., V_{CUR}→V_{TAR}). Such a linear behavioral model is shaped with a y-intercept that is set to a value which corresponds to an actuator in idle mode (e.g., u[n]=0, duty cycle=100%→heat actuator no longer contributes heat) and a slope parameter, m, that dictates the factor by which actuator responsivity changes with u[n] (e.g., m=0.001→duty cycle changes by 1 for every 1000× increase in u[n]). The plant system environment may be constrained to begin at the point denoted by the y-intercept.

A first condition of the example plant system process may comprise V_{CUR}>V_{TAR}, the resulting error is negative, the proportional and integral contribution are negative, and the derivative parameter is positive. In the first condition, T_{CUR} may be increased to reach T_{TAR}. TO increase T_{CUR}, the PWM duty cycle may be decreased to turn on and increase the temperature on the conductive material. If the proportional (K_{P}) and integral (K_{I}) parameters dominate u[n], then the PWM duty cycle decreases as u[n] decreases.

A second condition of the example plant system process may comprise V_{CUR}<V_{TAR}, the resulting error is positive, the proportional (K_{P}) and integral (K_{I}) parameters are positive, and the derivative parameter is negative. In the second condition, T_{CUR} may be decreased to reach T_{TAR}. To decrease T_{CUR}, the PWM duty cycle may be increased to progressively reduce its effect on V_{CTAT} so that the heat actuator turns off and causes the temperature on the conductive material to decrease. If the proportional (K_{P}) and integral (K_{I}) parameters dominate u[n], then the PWM duty cycle increases as u[n] increases.

A third condition of the example plant system process may comprise V_{CUR}=V_{TAR}, the resulting error is zero and the proportional (K_{P}) and integral (K_{D}) parameters may no longer have any contribution to u[n], and the integral parameter maintains zero steady state error by holding u[n].

Although the plant system may conform to a linear behavioral model, regulation in the process variable (V_{CUR}) may not lend itself to compliance with a single linear mapping function under all operating conditions. While using a single predetermined linear mapping function, it may be assumed that a local optimum control quantity (K_{P}, K_{I}, K_{D}) is made to meet all performance requirements for a static ambient temperature condition. However, if the same control quantity (K_{P}, K_{I}, K_{D}) is applied in other temperature regions, similar performance outcomes may not ensue because the plant system process may demonstrate unprecedented nonlinear behavior in a dynamic state where the purported linear model roughly applies. Thus, any control quantity contrived on a single linear mapping function may not be equal across all temperatures.

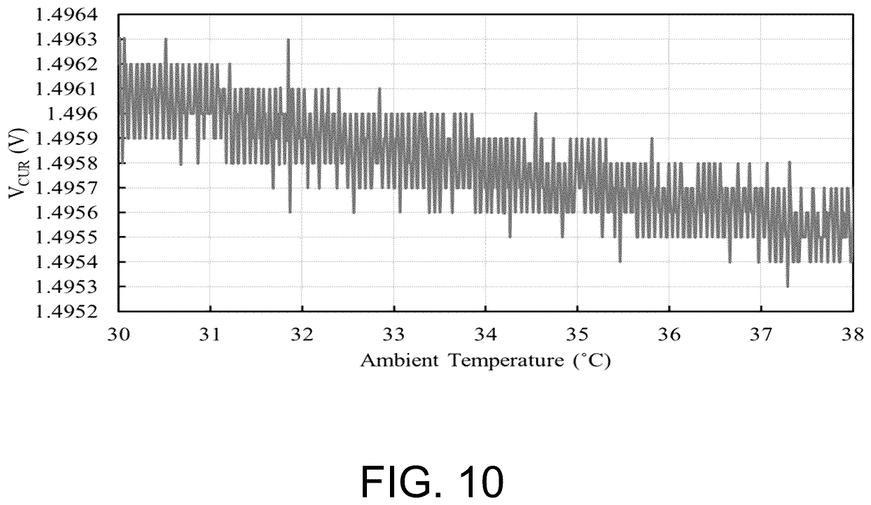

FIG. 10 depicts example measurements associated with stabilizing a process variable of a plant system. Measurement results depicted in FIG. 10 illustrate the aforementioned performance disadvantages. For example under a single predetermined linear mapping function, usage of a single local optimum control quantity (K_{P}, K_{I}, K_{D}) may introduce plant system output drift in the stabilization of V_{CUR} at approximately 1.4960V, which respectively corresponds to T_{TAR}=45° C. Thus, FIG. 10 contends that a local optimum control quantity (K_{P}, K_{I}, K_{D}) confined to a single predetermined linear mapping function is not universal in every operating condition (e.g., a local optimum control quantity (K_{P}, K_{I}, K_{D}) designed exclusively to stabilize V_{CUR} near V_{TAR} in one static temperature does not belong to the same set of local optima at other ambient temperatures).

The slope of the linear mapping function may be modified to modulate the control signal u[n] to best fit a global optimum throughout every ambient temperature, regardless of the static temperature the controller's response was best optimized for. By modifying the slope of the linear mapping function according to the plant system output's (V_{CUR}) moving average, a controller preset with a local optimum control quantity (K_{P}, K_{I}, K_{D})—specifically configured for one static ambient temperature—may be indirectly fine-tuned through the modulation of u[n] to suppress the drift phenomenon seen in FIG. 10 in all temperature regions.

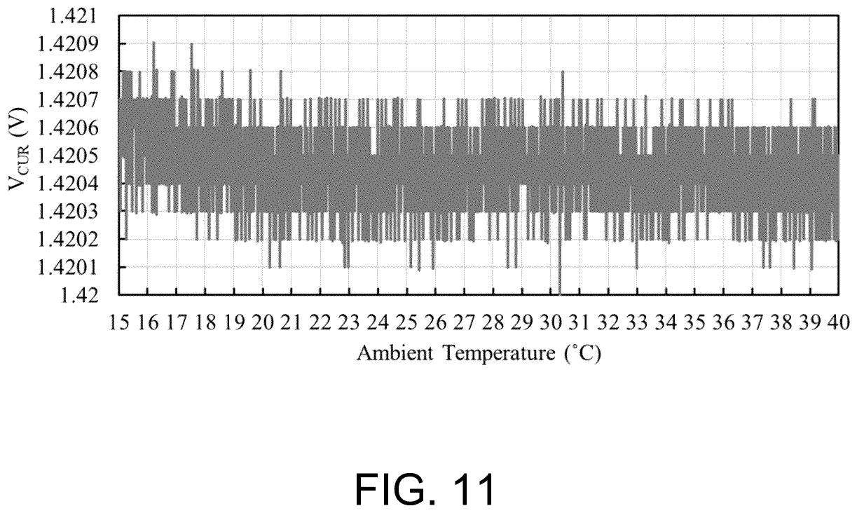

FIG. 11 depicts improved measurements associated with stabilizing a process variable of a plant system in accordance with some embodiments of the present disclosure. As depicted, stabilization of V_{CUR} about 1.4205V corresponds to T_{TAR}=45° C.

### Example System Operations

Various embodiments of the present disclosure describe steps, operations, processes, methods, functions, and/or the like for performing adaptive PID control within a plant system process.

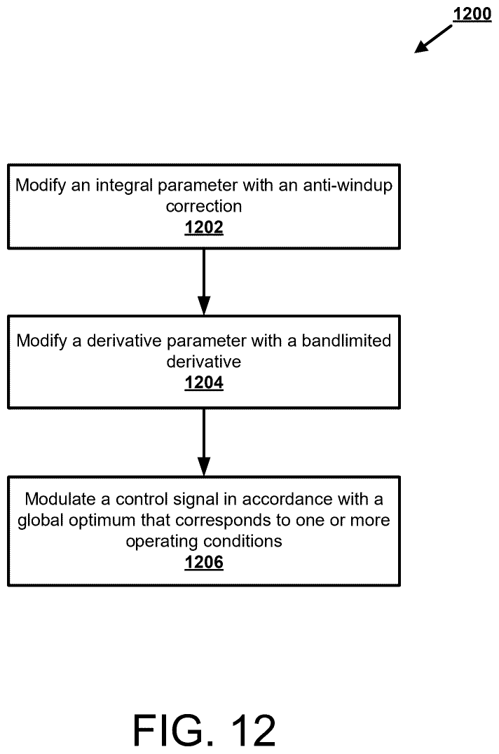

FIG. 12 is a flowchart of an example process 1200 for performing adaptive PID control according to some embodiments of the present disclosure.

In some embodiments, the process 1200 begins at step/operation 1202 when a MCU modifies an integral parameter with an anti-windup correction. The anti-windup correction may be used to resolve actuator saturation. In some embodiments, the anti-windup correction comprises integrator clamping.

In some embodiments, at step/operation 1204, the MCU modifies a derivative parameter with a bandlimited derivative. By doing so, causality and stability may be attained while attenuating high frequency noise. In some embodiments, the bandlimited derivative comprises a Butterworth low-pass filter structure with N-order, L-filter levels coupled with a complex derivative parameter.

In some embodiments, at step/operation 1206, the MCU modulates a control signal in accordance with a global optimum that corresponds to one or more operating conditions of a plant system. In some embodiments, modulating the control signal comprises verifying a plant system process corresponding to the plant system adheres to a linear behavioral model; generating a linear mapping function, wherein a y-intercept configures no action in the plant system process and a slope parameter dictates a factor by which responsivity in a control parameter adjusts with the control signal; static tuning one or more PID parameters (K_{P}, K_{I}, K_{D}) under a constant operating condition; and applying slope tuning on the linear mapping function to facilitate dynamic operation of the plant system process. In some embodiments, verifying the plant system process adheres to the linear behavioral model comprises identifying one or more process variables and one or more control parameters belonging to the plant system process; and assessing how the one or more process variables behave in response to incremental changes to the one or more control parameters. In some embodiments, generating the linear mapping function comprises determining the y-intercept with a coordinate that corresponds to no action in the plant system process and flexibly shapes the slope parameter, thereby enabling high resolution responsivity in the control parameter.

In some embodiments, static tuning the one or more PID parameters comprises maintaining no change in the linear mapping function; initializing the plant system process with a behavior described by the y-intercept in the linear mapping function; maintaining the plant system process under a constant operating condition; and obtaining a local optimum control quantity corresponding to the one or more PID parameters by conducting empirical trials on the plant system process. In some embodiments, applying the slope tuning comprises determining how the plant system process reacts to one or more changes in the linear mapping function, thereby allowing knowledge of how to apply sloping tuning; determining M number of points in a moving average of a process variable of the one or more process variables, wherein a highest reduction in random white noise of the control signal is achieved to gain information about a current behavior of the process variable; forming a boundary around the process variable, thereby adhering the moving average to the boundary to determine if drift occurs in the process variable; modifying a slope of the linear mapping function by a constant margin, wherein modifying the slope adjusts the responsivity of the plant system process, thereby establishing global optimum control throughout the plant's operating range and improving the plant's system response with mitigation in drift of the process variable based on the local optimum control quantity determined from static tuning.

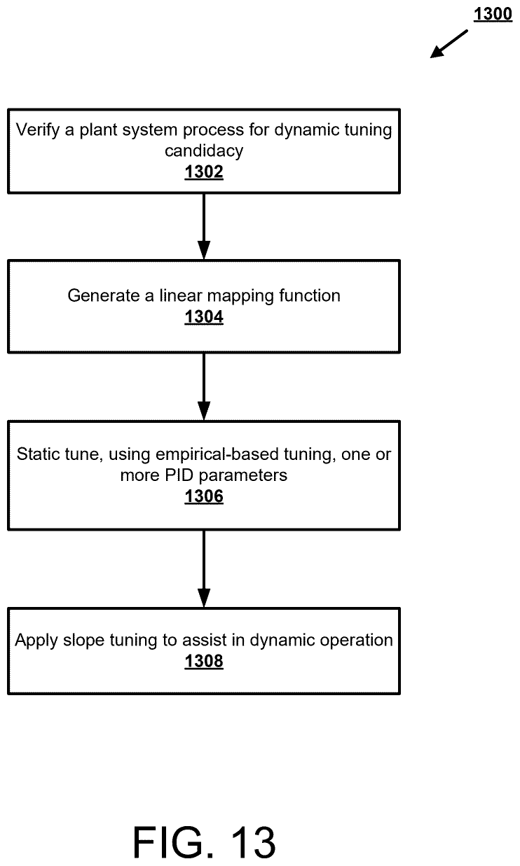

FIG. 13 is a flowchart of an example dynamic PID heuristic process 1300 for stabilizing a process variable of a plant system in accordance with some embodiments of the present disclosure.

In some embodiments, the process 1300 begins at step/operation 1302 when a MCU verifies a plant system process for dynamic tuning candidacy.

In some embodiments, verifying the plant system process comprises determining a process variable (e.g., V_{CUR}) and a control parameter (e.g., PWM signal) that influences a position of the process variable; generating a behavioral model of the plant system process; and determining how the process variable reacts to the control parameter. In some embodiments, if the process variable reacts linearly to the control parameter, then dynamic tuning is compatible with the plant system process and may proceed.

In some embodiments, at step/operation 1304, the MCU generates a linear mapping function. In some embodiments, generating the linear mapping function comprises determining a y-intercept that corresponds to the control parameter prompting no action in the plant system process (e.g., actuator in idle mode→u[n]=0, duty cycle=100%→heat actuator no longer contributes heat); determining a slope parameter, m, that dictates a factor by which responsivity in the control parameter adjusts with a control signal (e.g., m=0.001→every 1000× increase in u[n] changes the PWM duty cycle by 1%); and generate, using a point-slope form, the linear mapping function. In some embodiments, the plant system process may be constrained to begin at a point denoted by the y-intercept.

In some embodiments, at step/operation 1306, the MCU static tunes, using empirical-based tuning, one or more PID parameters. In some embodiments, static tuning the one or more PID parameters comprises maintaining the slope parameter at constant (e.g., to create no changes in the linear mapping function); initializing a proportional parameter K_{P}, an integral parameter K_{I}, and a derivative parameter K_{D} to 0 and maintaining an operating condition of the plant system process at constant (e.g., the ambient temperature of the device package held at constant temperature); determining a proportional parameter value by modifying and/or increasing the proportional parameter K_{P} until steady-state error is low while maintaining the integral parameter K_{I} and the derivative parameter K_{D} at constant; determining an integral parameter value by modifying and/or increasing the integral parameter K until steady-state error is eliminated while maintaining the proportional parameter K_{P} and the derivative parameter K_{D} at constant; determining a derivative parameter value by modifying and/or increasing the derivative parameter K_{D} as appropriate to relax oscillations and improve settling time while maintaining the proportional parameter K_{P} and the integral parameter K_{I} at constant; and maintaining one or more of the proportional parameter value, the integral parameter value, or the derivative parameter value as a local optimum control quantity.

In some embodiments, at step/operation 1308, the MCU applies slope tuning on the linear mapping function in providing dynamic operation of the plant system process. In some embodiments, applying slope tuning comprises determining how the plant system process reacts to changes in the linear mapping function. The linear mapping function may be refined to tune the control parameter (e.g., PWM signal). For example, if the moving average of the process variable decreases below a lower bound of a set point (e.g., V_{TAR}), the linear mapping function may skew T_{CUR} too far above T_{TAR}. To relieve excessive temperature control, the slope parameter may be decreased to cause a graduate increase in duty cycle that fosters T_{CUR} to approach T_{TAR}. In another example, if the moving average of process variable increases above an upper bound of the set point, the linear mapping function may skew TUR too far below T_{TAR}. To relieve insufficient temperature control, the slope parameter may be increased to cause a graduate decrease in duty cycle that fosters T_{CUR} to approach T_{TAR}. As another example, if the moving average of process variable equals the set point, the linear mapping function may indicate T_{CUR}=T_{TAR} and no changes may be made to the linear mapping function.

In some embodiments, applying slope tuning comprises configuring M number of points in the moving average of the process variable; configuring an upper and lower bound near the set point to constrain the moving average of the process variable to comply within; and configuring a constant margin to add or subtract from the slope parameter to provide a change to a responsivity of a mapping profile. In some embodiments, applying slope tuning comprises waiting a time limit for the process variable to first stabilize between an established boundary before modifying slope parameters. After waiting for the time limit, slope tuning may be applied by changing the slope parameter of the linear mapping function by the constant margin. The constant margin may be adjusted as necessary through trial and error to improve the plant's system response, as desired or appropriate.

According to various embodiments of the present disclosure, a moving average filter is used to isolate the effects of random white noise to make signal trends in the process variable (e.g., V_{CUR}) clearly visible. A moving average filter may utilize a finite impulse response h[n] as a kernel to convolve an input signal x[n]. Convolution may operate to reveal essential patterns in an input signal by averaging M number of points on the signal in each iteration.

$$y [ n ] = x [ n ] * h [ n ] = {\sum }_{k = - ∞}^{∞} h [ k ] x [ n - k ] = \frac{1}{M} {\sum }_{k = 0}^{M - 1} x [ n - k ] \qquad Equation 13$$

Given that the moving average filter may be characterized by its impulse response h[n], a frequency response of the moving average filter may be described by a discrete-time Fourier transform (DTFT) where

$$ω = \frac{2 π f}{{f}_{s}}$$

may represent the normalized angular frequency in rad/sample. If the sum of a geometric series is expressed as

$${\sum }_{i = 0}^{n - 1} {a}_{1} {r}^{i} = \frac{{a}_{1} ( 1 - {r}^{n} )}{1 - r} and {e}^{j ω} - {e}^{- j ω} = 2 j sin ( ω ) , \qquad Equation 14$$

the following may be derived using DTFT:

$$\vert H ( {e}^{j ω} ) \vert = \vert {\sum }_{n = 0}^{M - 1} h [ n ] {e}^{- j ω n} \vert = \vert \frac{1}{M} {\sum }_{n = 0}^{M - 1} {e}^{- j ω n} \vert = \vert \frac{1}{M} \frac{( 1 - {e}^{- j ω M} )}{( 1 - {e}^{- j ω} )} \vert = \vert \frac{1}{M} \frac{sin ( \frac{ω M}{2} )}{sin ( \frac{ω}{2} )} \vert \qquad Equation 15$$

The moving average filter may not be designed with any strict frequency domain requirement because its frequency domain may have attributes of slow roll-off and poor stop-band attenuation. The moving average filter sacrifices such frequency domain properties to acquire strengths in the time domain. That is, the moving average filter's property of smoothening data may be optimal for achieving the highest reduction in random white noise while keeping the sharpest step response. When implemented recursively, the moving average filter may use two computations per point, regardless of the length of the filter kernel h[n]. Thus, the choice of a moving average filter permits access to fast, efficient heuristic algorithm designs.

$$y [ n ] = \frac{1}{M} {\sum }_{k = 0}^{M - 1} x [ n - k ] = \frac{x [ n ] + x [ n - 1 ] + … + x [ n - ( M - 1 ) ]}{M} = \frac{x [ n ] + y [ n - 1 ] - x [ n - M ]}{M} \qquad Equation 16$$

According to various embodiments, a dynamic PID control system is applicable to various domains, such as:
1. Automotive Systems
   Adaptive Cruise Control: Dynamic PID controllers may adjust the throttle and brakes in real time to maintain a safe distance from other vehicles, considering varying road slopes, traffic, and vehicle speed.
   Engine Control: Dynamic PID controllers may manage fuel injection, turbochargers, and emission controls in real time based on changing engine conditions.
2. Aerospace and UAVs
   flight Control Systems: Dynamic PID systems may help maintain stability in changing atmospheric conditions, managing altitude, speed, and orientation for drones and aircrafts.
   Missile Guidance Systems: Dynamic PID controllers may be used to continuously adapt to changing environmental factors, thereby improving precision and control under high speeds and dynamic conditions.
3. Industrial Automation
   Robotic Arm Control: Adaptive PID controllers may be used to optimize robotic arm movements to handle variable payloads, changes in the object's weight, and desired precision.
   Temperature Control in Furnaces: Dynamic PID controllers may be used to perform real-time adjustments in heating or cooling prevent overshoot and maintain precise temperature control in variable loads or fluctuating environmental conditions.
4. Renewable Energy
   Wind Turbine Control: Dynamic PID systems may be used to adjust the blade pitch and generator torque to optimize power generation based on changing wind speeds and directions.
   Solar Panel Tracking: Dynamic PID controllers may facilitate continuous alignment adjustments to optimize energy capture, accounting for the sun's position, shadows, and weather variations.
5. Medical Devices
   Automated Drug Delivery Systems: Dynamic PID controllers may provide real-time adjustments in infusion rates based on patient vitals or feedback ensure precise dosage delivery.
   Prosthetic Limbs: Dynamic PID controllers may be used to provide adaptive control in prosthetics to offer smooth and responsive movements by adjusting to changes in the user's gait, weight, and environment.
6. Chemical Process Control
   Reactor Temperature and Pressure Control: PID controllers may manage variables to maintain optimal conditions for reactions, adjusting to changes in reactant feed rates or exothermic reactions.
   pH Control in Water Treatment Plants: Dynamic PID controllers may be used to continuously adjust chemical dosing based on water inflow characteristics, aiding in precise pH maintenance.
7. HVAC Systems
   Building Climate Control: Dynamic PID controls may adjust heating, ventilation, and cooling in real time based on room occupancy, weather conditions, and other environmental changes to maintain comfort and efficiency.
8. Agriculture
   Automated Irrigation Systems: Dynamic PID controllers may adaptively adjust water flow based on soil moisture, crop requirements, and weather changes to ensure optimal water usage and crop health.
   Greenhouse Climate Control: Dynamic PID controllers may maintain optimal humidity, temperature, and CO₂ levels dynamically for plant growth.
9. Maritime Navigation
   Dynamic Positioning of Vessels: Using dynamic PID control systems, vessels may be able to maintain a fixed position despite current, wind, and wave changes, essential for offshore drilling and docking maneuvers.

According to various embodiments, market spaces that may benefit from the disclosed dynamic PID system include:
1. Automotive Manufacturers
   Safety features, such as adaptive cruise control, autonomous driving, and fuel efficiency may be enhanced through dynamic PID controllers, offering more responsive and efficient vehicle systems.
   Major suppliers of automotive components may integrate adaptive PID control in systems, such as electronic stability, brake control, and engine management systems.
2. Aerospace and Defense
   Dynamic PID systems may be leveraged for applications in flight control, missile guidance, and UAV stabilization, critical for safe and precise operation in variable conditions.
   For UAVs and autonomous vehicles in defense, dynamic PID's may enhance control in remote, unpredictable environments.
3. Renewable Energy Companies
   Wind turbine manufacturers benefit from dynamic PID to maximize power generation by adapting to changing wind conditions, reducing mechanical stress on turbines.
   Solar tracking systems using adaptive PID may allow for capturing of optimal sunlight despite cloud cover, shadows, or solar position changes.
4. Industrial Automation Providers
   Dynamic PID may be used in robotic arms, conveyor systems, and process control for enhanced precision and adaptability in manufacturing processes.
   Robotic and automation companies may benefit from dynamic PID for responsive, adaptive robotic movement in assembly lines, handling tasks with high precision despite fluctuating loads or environmental conditions.
5. Medical Device Manufacturers
   For infusion pumps, ventilators, and other automated medical devices, patient safety may be improved by using dynamic PID for precise dosing and adaptive control based on real-time patient data.
   Prosthetic limb manufacturers may benefit from adaptive control for smoother and more responsive movement, improving the user experience in various conditions.
6. Chemical and Process Industries
   Chemical companies may benefit from enhanced PID control for maintaining reactor stability, temperature, pressure, and mixing control, essential for safe, efficient, and high-quality chemical production.
   For refining and petrochemical processes, dynamic PID control may help maintain optimal operating conditions, improving energy efficiency and reducing emissions.
7. HVAC and Building Management Companies
   Adaptive PID control may be used in HVAC systems to optimize energy use based on occupancy and environmental changes, providing consistent indoor climate control while reducing energy costs.
   Advanced building management systems using dynamic PID may help maintain optimal temperature and air quality in smart buildings, enhancing energy savings and comfort.
8. Agricultural Technology Companies
   Automated irrigation systems with dynamic PID control may help optimize water use by adjusting based on crop needs and weather changes, leading to higher crop yields with efficient resource use.
   Companies in controlled-environment agriculture, such as greenhouse operations, may use PID for climate control, ensuring precise temperature, humidity, and CO₂ levels to optimize crop growth.
9. Maritime and Offshore Companies
   Dynamic PID may be valuable for offshore drilling and shipping, enabling dynamic positioning systems to stabilize vessels despite changing ocean conditions, ensuring safe and efficient maritime operations.
   Maritime equipment companies may use adaptive PID for stabilizing ships, controlling propulsion systems, and improving energy efficiency in various sea states.
10. Technology Companies in Robotics and AI
   Robotics companies working on autonomous or semi-autonomous robots may benefit from dynamic PID for real-time adjustment to ensure stability and adaptability in uncertain environments.
   As companies develop AI and robotics platforms, dynamic PID may be used in control algorithms for autonomous systems, enhancing stability, precision, and reaction speed.

By integrating dynamic PID controllers, the aforementioned companies may achieve higher efficiency, reduce costs, improve safety, and enhance product performance in response to rapidly changing operational conditions.

### CONCLUSION

It should be understood that the examples and embodiments described herein are for illustrative purposes only and that various modifications or changes in light thereof will be suggested to persons skilled in the art and are to be included within the spirit and purview of this application.

Many modifications and other embodiments of the present disclosure set forth herein will come to mind to one skilled in the art to which the present disclosures pertain having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claim concepts. Although specific terms are employed herein, they are used in a generic and descriptive sense only and not for purposes of limitation.

1. A computer-implemented method comprising:
modifying, by one or more processors, an integral parameter with an anti-windup correction;
modifying, by the one or more processors, a derivative parameter with a bandlimited derivative; and
modulating, by the one or more processors, a control signal in accordance with a global optimum that corresponds to one or more operating conditions of a plant system.

2. The computer-implemented method of claim 1, wherein the anti-windup correction comprises integrator clamping that resolves actuator saturation.

3. The computer-implemented method of claim 1, wherein the bandlimited derivative comprises a Butterworth low-pass filter structure with N order, L-filter levels coupled with a complex derivative parameter.

4. The computer-implemented method of claim 1, wherein modulating the control signal comprises:
verifying a plant system process corresponding to the plant system adheres to a linear behavioral model;
generating a linear mapping function, wherein a y-intercept configures no action in the plant system process and a slope parameter dictates a factor by which responsivity in a control parameter adjusts with the control signal;
static tuning one or more of the integral parameter, the derivative parameter, or a proportional parameter under a constant operating condition; and
applying slope tuning on the linear mapping function to facilitate dynamic operation of the plant system process.

5. The computer-implemented method of claim 4, wherein verifying the plant system process comprises:
identifying one or more process variables and one or more control parameters belonging to the plant system process; and
assessing how the one or more process variables behave in response to one or more incremental changes to the one or more control parameters.

6. The computer-implemented method of claim 4, wherein generating the linear mapping function comprises:
determining the y-intercept with a coordinate that corresponds to the no action in the plant system process and flexibly shapes the slope parameter.

7. The computer-implemented method of claim 4, wherein static tuning comprises:
maintaining no change in the linear mapping function;
initializing the plant system process with a behavior described by the y-intercept in the linear mapping function;
maintaining the plant system process under the constant operating condition; and
obtaining a local optimum control quantity corresponding to one or more of the integral parameter, the derivative parameter, or the proportional parameter.

8. The computer-implemented method of claim 4, wherein applying the slope tuning comprises:
determining how the plant system process reacts to one or more changes in the linear mapping function;
determining M number of points in a moving average of a process variable;
forming a boundary around the process variable;
modifying a slope of the linear mapping function by a constant margin.

9. A computer-implemented method comprising:
verifying, by one or more processors, a plant system process for dynamic tuning candidacy;
generating, by the one or more processors, a linear mapping function;
static tuning, by the one or more processors, one or more of an integral parameter, a derivative parameter, or a proportional parameter; and
applying, by the one or more processors, slope tuning on the linear mapping function in providing dynamic operation of the plant system process.

10. The computer-implemented method of claim 9, wherein verifying the plant system process comprises:
determining a process variable and a control parameter;
generating a behavioral model of the plant system process; and
determining how the process variable reacts to the control parameter.

11. The computer-implemented method of claim 10 further comprising, responsive to a moving average of the process variable decreasing below a lower bound of a set point, decreasing a slope parameter of the linear mapping function.

12. The computer-implemented method of claim 10 further comprising, responsive to a moving average of the process variable increasing above an upper bound of a set point, increasing a slope parameter of the linear mapping function.

13. The computer-implemented method of claim 9, wherein generating the linear mapping function comprises:
determining a y-intercept that corresponds to a control parameter prompting no action in the plant system process;
determining a slope parameter that dictates a factor by which responsivity in the control parameter adjusts with a control signal; and
generating, using a point-slope form, the linear mapping function.

14. The computer-implemented method of claim 9, wherein static tuning one or more of the integral parameter, the derivative parameter, or the proportional parameter comprises:
maintaining a slope parameter at constant;
initializing the proportional parameter, the integral parameter, and the derivative parameter to 0 and maintaining an operating condition of the plant system process at constant;
determining a proportional parameter value by modifying or increasing the proportional parameter until a steady-state error is low while maintaining the integral parameter and the derivative parameter at constant;
determining an integral parameter value by modifying or increasing the integral parameter until the steady-state error is eliminated while maintaining the proportional parameter and the derivative parameter at constant;
determining a derivative parameter value by modifying or increasing the derivative parameter as appropriate to relax oscillations and improve settling time while maintaining the proportional parameter and the integral parameter at constant; and
maintaining one or more of the proportional parameter value, the integral parameter value, or the derivative parameter value as a local optimum control quantity.

15. The computer-implemented method of claim 9, wherein applying slope tuning comprises determining how the plant system process reacts to one or more changes in the linear mapping function.

16. The computer-implemented method of claim 9, wherein applying slope tuning comprises:
configuring M number of points in a moving average of a process variable;
configuring an upper bound and a lower bound relative to a set point; and
configuring a constant margin to add or subtract from a slope parameter of the linear mapping function.

17. The computer-implemented method of claim 16, wherein applying slope tuning comprises:
waiting a time limit for the process variable to stabilize between an established boundary; and
after the time limit, changing the slope parameter by the constant margin.
